(19) United States
(12) Patent Application Publication
(10) Pub. No.: US 2024/0037876 A1
(43) Pub. Date: Feb. 1, 2024

(54) ENVIRONMENT EXPERIENCING METHOD AND APPARATUS IN AUGMENTED REALITY, AND ELECTRONIC DEVICE AND STORAGE MEDIUM THEREOF

(71) Applicant: iView Displays (Hong Kong) Company Limited, Hongkong (CN)

(72) Inventors: Mingnei Ding, Shenzhen (CN); Steve Yeung, Hongkong (CN); Zhiqiang Gao, Hongkong (CN)

(21) Appl. No.: 18/379,245

(22) Filed: Oct. 12, 2023

Related U.S. Application Data
(63) Continuation of application No. PCT/CN2021/106083, filed on Jul. 13, 2021.

(30) Foreign Application Priority Data
Apr. 27, 2021 (CN) 202110459154.7

(51) Int. Cl. G06T 19/00

(52) U.S. Cl. CPC G06T 19/006

(57) ABSTRACT

An environment experiencing method and apparatus in augmented reality, and an electronic device are provided. The environment experiencing method in augmented reality includes: an item select instruction is received; a simulated environment of a specified item is generated based on the item select instruction; a simulated image is generated and applied to the simulated environment; and an interaction action is received from a user and the interaction action is responded to.

### CROSS-REFERENCE TO RELATED APPLICATION

This application is a continuation of International Application No. PCT/CN2021/106083, with an international filing date of Jul. 13, 2021, which is based upon and claims priority to Chinese Patent Application No. 2021104591547, filed with the Chinese Patent Office on Apr. 27, 2021, titled “ENVIRONMENT EXPERIENCING METHOD AND APPARATUS IN AUGMENTED REALITY, AND ELECTRONIC DEVICE AND STORAGE MEDIUM THEREOF”, the entire contents of which are incorporated herein by reference.

### TECHNICAL FIELD

The present disclosure relates to the technical field of augmented reality, and in particular, relates to an environment experiencing method and apparatus in augmented reality, and an electronic device.

### BACKGROUND

In recent years, in virtual reality, an object, a scenario, and the like in a real world are simulated and emulated by computer-based three-dimensional modeling. However, such emulation is static, and in the case that related variables of a real environment change, the change may not be reflected immediately. From the perspective of content experience of the virtual reality, in the case that environmental variables involved in the content change, the real environment of an experiencer may not change. At present, no technology is available to enable a user to immersively experience a natural environment indoors.

### SUMMARY

In a first aspect, the embodiments of the present disclosure provide an environment experiencing method in augmented reality. The method includes: receiving an item select instruction, generating a simulated environment of a specified item based on the item select instruction, generating a simulated image and applying the simulated image to the simulated environment; and receiving an interaction action from a user and responding to the interaction action.

In a second aspect, the embodiments of the present disclosure further provide an electronic device. The electronic device includes: at least one processor, and a memory communicably connected to the at least one processor, wherein the memory stores one or more instructions executable by the at least one processor, wherein the at least one processor, when executing the one or more instructions, is caused to perform the method as described above.

In a third aspect, the embodiments of the present disclosure further provide a non-volatile computer-readable storage medium storing one or more computer-executable instructions; wherein the one or more computer-executable instructions, when executed by an electronic device, cause the electronic device to perform the method as described above.

### BRIEF DESCRIPTION OF THE DRAWINGS

One or more embodiments are illustrated by way of example, and not by limitation, in the accompanying drawings, wherein components having the same reference numeral designations represent like components throughout. The drawings are not to scale, unless otherwise disclosed.

FIG. 1 is a schematic flowchart of an environment experiencing method in augmented reality according to some embodiments of the present disclosure;

FIG. 2 is a specific flowchart of S12 in FIG. 1;

FIG. 3 is a specific flowchart of S13 in FIG. 2;

FIG. 4 is a schematic flowchart of an environment experiencing method in augmented reality according to some embodiments of the present disclosure;

FIG. 5 is a schematic structural diagram of an environment experiencing apparatus in augmented reality according to some embodiments of the present disclosure; and

FIG. 6 is a schematic structural diagram illustrating hardware of an electronic device for performing an environment experiencing method in augmented reality according to some embodiments of the present disclosure.

### DETAILED DESCRIPTION

For better understanding of the present disclosure, the present disclosure is described in detail with reference to some specific embodiments. The embodiments hereinafter facilitate further understanding of the present disclosure for a person skilled in the art, rather than causing any limitation to the present disclosure. It should be noted that persons of ordinary skill in the art may derive various variations and modifications without departing from the inventive concept of the present disclosure. Such variations and modifications shall pertain to the protection scope of the present disclosure. Unless the context clearly requires otherwise, throughout the specification and the claims, technical and scientific terms used herein denote the meaning as commonly understood by a person skilled in the art. Additionally, the terms used in the specification of the present disclosure are merely for describing the objects of the specific embodiments, and are not intended to limit the present disclosure.

It should be noted that, in the absence of conflict, embodiments of the present disclosure and features in the embodiments may be incorporated, which all fall within the protection scope of the present disclosure. In addition, although function module division is illustrated in the schematic diagrams of devices, and in some occasions, module division different from the divisions of the modules in the devices may be used.

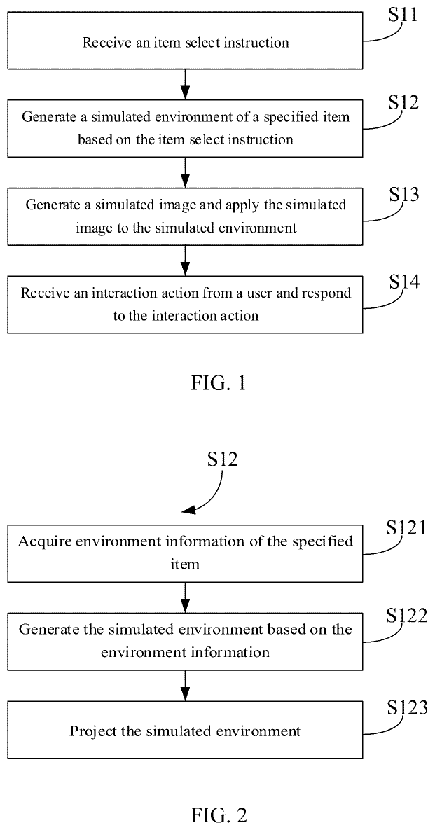

Referring to FIG. 1, FIG. 1 is a schematic flowchart of an environment experiencing method in augmented reality according to some embodiments of the present disclosure. The method is applicable to an electronic device. The method includes the following steps.

In S11, an item select instruction is received. A user selects, by an input device, an item that he or she wants to experience, including an item manually selected or input by the user via a touch screen, an item selected by the user via a voice input device, or an item selected by the user via a remote joystick, or the like. A display screen or a touch screen displays a selectable item for the user, and locks and displays the item to the user upon receiving the item select instruction of the user.

In S12, a simulated environment of a specified item is generated based on the item select instruction. Prior to generation of the simulated environment, a spatial range of an actual indoor site needs to be determined first. For example, a boundary of the actual indoor site may be predetermined in combination with a camera, a sensor or other measuring devices, the item select instruction of the user is received and an item environment that needs to be simulated is determined, and the simulated environment is generated in combination with the spatial scope of the actual indoor site and the generated simulated environment is presented to the user. Referring to FIG. 2, generating the simulated environment of the specified item based on the item select instruction specifically includes the following steps S121-S123.

In S121, environment information of the specified item is acquired. Upon receiving the item select instruction of the user, and confirming the experience item of the user, the environment information of the specified item is acquired from a database of a system, or the environment information of the specified item is acquired via the Internet upon networking. For example, in the case that the user wants to experience a skiing item, and selects to experience the skiing item in Snow Mountain Ski Resort, a device acquires environment information near the Snow Mountain Ski Resort from the database or via the Internet, wherein the environment information includes the number of snow tracks in the ski resort, the trends of the snow tracks, nearby obstacles, or the like information, and the device also acquires information of weather conditions suitable for skiing, wherein the information of the weather condition includes wind speed, snowfall amount, and air temperature suitable for skiing.

In S122, the simulated environment is generated based on the environment information. Upon acquiring the environment information, the device simulates a virtual scenario based on the environment information, creates a simulated environment approximate to a real world, and creates an immersive atmosphere for the user. During environment simulation, an appropriate simulated environment may be selected according to the scope of the actual indoor site. Taking experience of the skiing item as an example, in the case that the indoor site is large, multiple snow tracks may be simulated for the user's choice, and a larger field of view is provided; in the case that the indoor site is not large, a skiing scenario with a small field of view is provided. The boundary of the indoor site is detected in combination with a distance sensor, or the like device; and during environment simulation, an action range of the user is controlled within the range of the indoor site to ensure that the user does not go outside an experience site during the actual experience. The device may also restore the environment weather as real as possible according to the set weather information. For example, in the case that the set environment is a low temperature and snowing weather, the device may simulate a thick snow layer covering the building in the environment, and occasionally, snow pieces fall from branches to give the user the feeling of experiencing the skiing item in person.

In S123, the simulated environment is projected. The simulated environment is projected on a wall or other places, and a simulated scenario is presented for the user in cooperation with AR glasses or the like device worn by the user, such that the user sees an approximately real simulated environment using the AR glasses and the like device. For example, in the simulated environment of experiencing the skiing item, a dynamic effect of the wind blowing branches, and the footprints on the snow track, or the like may be displayed.

In S13, a simulated image is generated and applied to the simulated environment. The user may set personal information by himself or herself, and the device generates the simulated image of the user based on the set personal information and applies the simulated image to the simulated scenario to simulate an approximately real experience scenario for the user. The simulated image may be the simulated image with the user as a subject, or may be an image of a virtual teammate set by the user. For example, in the case that the user wants to set an image of having a skiing competition with a friend or an idol or even a stranger at the same time, the user may set his or her simulated images and teammates, and the device simulates stereoscopic images based on the information input by the user, applies the stereoscopic images to the environment, and presents the images to users in combination with AR glasses or the like device.

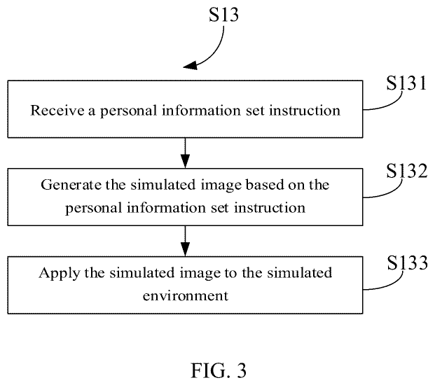

Optionally, referring to FIG. 3, generating the simulated image and applying the simulated image to the simulated environment specifically includes the following steps S131-S133.

In S131, a personal information set instruction is received. The user may set the personal information by the input device. For example, in the skiing experience item, the personal information set instruction includes, but is not limited to, setting the information such as his own ski suit style and the like, or the personal information such as gender, height or appearance of the virtual teammate; and upon receiving the personal information set instruction, the electronic device simulates the simulated images based on the personal information.

In S132, the simulated image is generated based on the personal information set instruction. The user may set his or her favorite simulated image in a setting interface of the simulation image. For example, in the skiing item, the user selects his or her favorite skiing clothes or skiing equipment in the database; and the electronic device analyzes and simulates appropriately-sized skiing clothes and skiing equipment based on the received user personal information, projects the same onto the body of the user, and provides a real three-dimensional display effect in combination with AR glasses or the like device, such that a real stereoscopic sense is brought to the user, and the user experience is improved. The user may also select to add his or her virtual teammate, and may set the image of the virtual teammate. Some initial simulated image models are stored in the database. In the case that the user does not want to set the image of the virtual teammate, the user may also directly select the simulated image model in the database as the simulated image of the virtual teammate, or select to make modification based on the simulated image model, and finally the simulated image of the virtual teammate is acquired.

In S133, the simulated image is applied to the simulated environment. For example, in the skiing experience item, the user may also select the snow track, and the electronic device applies the snow track selected by the user to the feet of the simulated image of the user or the virtual teammate and determines a starting position of the user and the virtual teammate skiing on the snow track. In addition, the user may set a skiing mode at will, such as a single-person single-track skiing practice or a multi-person skiing competition or the like, may also set start and end time of skiing, a skiing path which may be short-distance snow track skiing or unlimited snow track mode skiing or the like, or may also set the difficulty of skiing, such as the number of curves, slope of the snow track, or attributes of the obstacles on the snow track.

In S14, an interaction action is received from a user and the interaction action is responded to. The electronic device captures the action of the user in real time and changes the simulated environment according to the action of the user, so as to achieve fusion of simulated information and real information. Taking the experience of the skiing item as an example, the electronic device may receive a skiing action of the user in real time by an action capture system, and project a real-time changing scenario of the ski resort based on the skiing action. For example, in the case that the user swings a snow stick to accelerate skiing, the electronic device simulates an environment where backoff of the scenery on both sides of the snow track is accelerated. In addition, in the case that the user sets the virtual teammate accompanying the skiing, the electronic device randomly selects and simulates a skiing state process in which the virtual teammate accompanies the user to perform a skiing competition. The electronic device may also receive a voice instruction from the user and respond to the voice instruction. For example, the user cheers on himself or herself and his or her teammate before the skiing competition starts, and his or her teammate may also respond to the cheers of the user, such that reality of the item experienced by the user is improved.

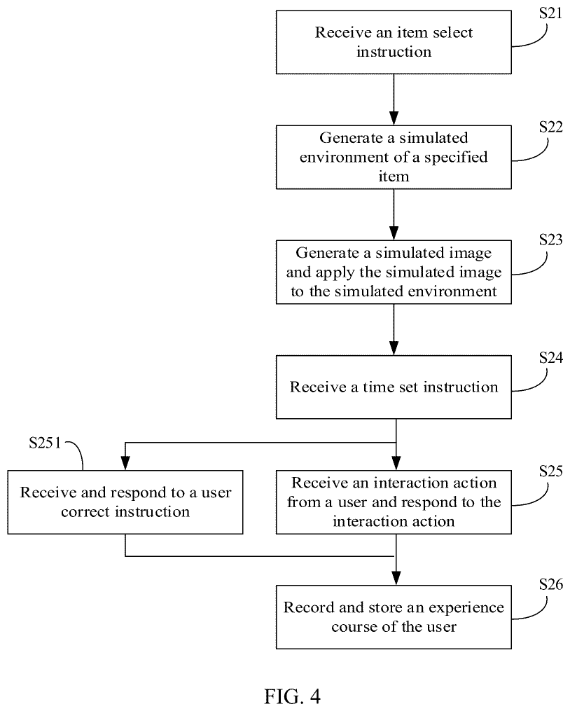

Referring to FIG. 4, FIG. 4 is a flowchart of an environment experiencing method in augmented reality according to some embodiments of the present disclosure. The method is applicable to an electronic device. The method specifically includes the following steps S21-S26.

In S21, an item select instruction is received. A user selects information of an item that he or she wants to experience by an input device. For example, the user wants to observe a living state of pandas in a natural environment, the electronic device searches for one or more items for observing the living state of the pandas in a database and displays the item to the user, and the user selects a specific experience item in an option to observe the living state of the pandas in Panda Nature Reserve.

In S22, a simulated environment of a specified item is generated. Upon receiving the item select instruction of the user, and confirming an experience item of the user, the electronic device may acquire environment information of the specified item from the database. Taking observation of the living state of the pandas as an example, the living information of various pandas including Panda Nature Reserve may be acquired over the Internet. Based on this, the living state of the pandas at ordinary times may be simulated and stereoscopic images may be displayed to the users, which includes simulating common behaviors of the pandas, such as eating foods, climbing trees, playing, or the like actions. In addition, the electronic device may also trigger environment details by receiving some specific action signals of the user. For example, when it is detected that the user has an action intention of approaching and touching the pandas, the electronic device triggers a panda's action of escaping, or it is detected that the user has the action of feeding foods, the electronic device triggers a panda's action of approaching foods and eating foods via a thrown food image, which may increase a real experience sense of the user.

In S23, a simulated image is generated and applied to the simulated environment. The electronic device displays a simulated scenario for the user. Taking observation of a living state of the pandas as an example, a living environment of the pandas may be simulated and projected by a projection device, the stereoscopic images of the pandas may be presented in combination with AR glasses or the like device worn by the user, and the stereoscopic images are applied to the projection environment, and daily behaviors of the pandas are simulated. Further, stereo sound effects of the pandas gnawing on food or climbing trees may also be simulated through a sound device, or the like.

In S24, a time set instruction is received. The user may set experience time including the time of entering the experience item and the time of ending the experience. In order to prevent the user from being overly addicted to the experience item, the experience time needs to be set before the experience item starts. In the meanwhile, an experience time period set by the user needs to be less than a maximum experience time within a specified range, and at the end of the experience time, the electronic device stops the experience item or makes a prompt to remind the user of exiting the experience item.

In S25, an interaction action from a user is received and responded to. Taking observation of the living environment of the pandas as an example, the electronic device displays the stereoscopic images of the pandas in the simulated environment in combination with the AR glasses or the like device, the action of the user is detected at any time by an action capture device, a camera or the like device, and the simulated environment and the images of the pandas are changed according to the action of the user, which is convenient for the user to observe the states of the pandas from different angles. For example, when it is detected that the user is approaching the pandas, the projected simulated environment is changed following the movement of the user, the field of view is drawn close to the pandas, and the reaction of the pandas when someone is approaching the pandas in real situations is simulated. In addition, in the case that the user sets a virtual passerby to accompany him or her to experience, the electronic device randomly selects and simulates the behaviors of the virtual passerby observing the living state of the pandas. The electronic device may also receive a voice instruction from the user and respond to the voice instruction, and support voice communication between the user and the virtual passerby and control the virtual passerby to randomly react to the language of the user.

In 251, a user correct instruction is received and responded to. In some cases, the electronic device may be subject to a situation of unclear projection or unsatisfactory response effect. In this case, the user may correct the situation by the input device such as a mobile phone or a remote control, correct the situation by function keys, or correct the situation by input a correction code via text or voice, or may input problem details and search for correction solutions over the Internet. For example, the user finds that a projected environment picture is unclear and sends the correct instruction to adjust the picture, and the electronic device responds to the instruction in time upon receiving the correct instruction of the user, for example, the electronic device adjusts clarity of the simulated projected picture. For example, in response to finding that the action of the projected image of an object is stuck or not smooth, the user sends the correct instruction by the input device to adjust smoothness of the image, and the electronic device responds to the correct instruction in time upon receiving the correct instruction of the user, wherein the response includes detecting whether an error is present in a simulated process of the image, detecting whether a delay is present in network transmission, detecting whether the projection device is faulty, or the like, such that transmission data information is adjusted so as to achieve an expected effect of the user.

In S26, an experience course of the user is recorded and stored. The electronic device also supports recording the experience item and experience course of the user, which includes the action and voice of the user during the experience. The electronic device records the action and voice of the user during an observation process in real time by a recording device such as a camera or a microphone, acquires the simulated and projected image information in the same period, corresponds the image information to the experience course of the user, synthesizes the images of the user in the experience course, and stores the synthesized images in a storage device. In this way, it is convenient for the user to review the experience course at that time later. Taking observation of the living state of the pandas as an example, in the case that the user misses some details of the pandas eating bamboos in the experience course, and he or she may carefully observe the missed details by watching the playback; or in the case that the user sees a video of the pandas giving birth in the experience course and wants to share the images with his or her friends, the user may capture clips from the stored playback video and send the clips to his or her friends.

In some other embodiments, the user may also experience an item online with a friend in a real word or other strangers who want to experience the item at the same time. For example, the user and his or her friend make an appointment to observe the living environment of the pandas together, may observe the pandas together in the same indoor experience site or experience separately in different indoor experience sites, and establish a real-time connection over the network, such that simulated image information of his or her friend is acquired, the simulated image is displayed next to the user, a friend's real-time action is acquired and the simulated image of the friend is controlled to make the same reaction, and the observation situation is discussed with the friend in real time during the observation process. The electronic device acquires scope information of the indoor site in advance. The scope information may be manually input by the user, or may be measured by a detection device such as a camera to measure an actual distance, and then a range boundary of the indoor site is calculated. Taking observation of living habits of the pandas as an example, the electronic device may change the display of the simulated scenario according to the scope of the indoor site. For example, the electronic device detects that the user is approaching the boundary of the indoor site, and simulates the scenario of the pandas walking to the other side and guides the user to move within the indoor site range, such that a better environment experience effect is provided to the user.

By simulating the environment of the experience item specified by the user, the action of the user is acquired and responded to in real time, such that the simulated environment approximate to a real world is created, and an immersive natural environment experience is provided to the user indoors.

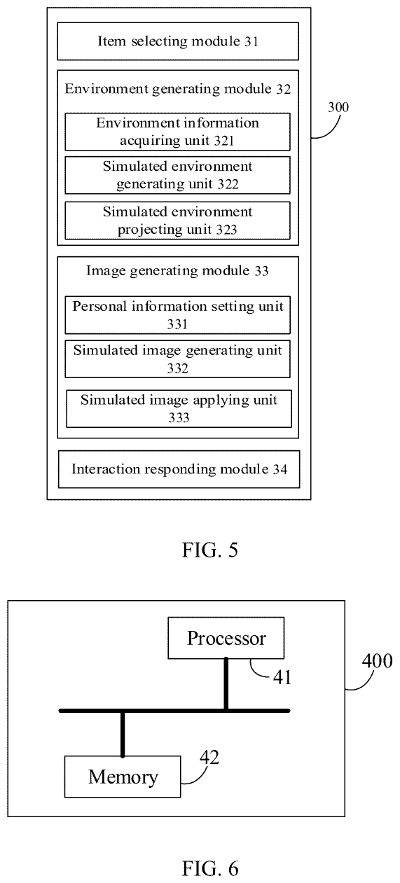

Referring to FIG. 5, FIG. 5 is a schematic structural diagram of an environment experiencing apparatus 300 in augmented reality according to some embodiments of the present disclosure. The apparatus 300 is applicable to an electronic device. The apparatus 300 includes: an item selecting module 31, an environment generating module 32, an image generating module 33, and an interaction responding module 34.

The item selecting module 31 is configured to receive an item select instruction. A user selects, by an input device, an item that he or she wants to experience, including an item manually selected or input by the user via a touch screen, an item selected by the user via a voice input device, or an item selected by the user via a remote controller, or the like. A display screen or a touch screen displays the selectable items for the user, and the item selecting module 31 locks and displays the item to the user upon receiving the item select instruction of the user.

The environment generating module 32 is configured to generate a simulated environment of a specified item based on the item select instruction. Upon receiving the item select instruction of the user, and confirming an experience item of the user, the environment generating module 32 may acquire environment information of the specified item from a database. Prior to generation of the simulated environment, a spatial range of an actual indoor site needs to be determined first. For example, a boundary of the actual indoor site may be predetermined in combination with a camera, a sensor or other measuring devices, the item select instruction of the user is received and an item environment that needs to be simulated is determined, and the simulated environment is generated in combination with the spatial scope of the actual indoor site and the generated simulated environment is presented to the user.

Optionally, the environment generating module 32 further includes an environment information acquiring unit 321, a simulated environment generating unit 322, and a simulated environment projecting unit 323.

The environment information acquiring unit 321 is configured to acquire environment information of the specified item. Upon receiving the item select instruction of the user, and confirming the experience item of the user, the environment information acquiring unit 321 may acquire the environment information of the specified item from the database of a system, or may acquire the environment information of the specified item via the Internet after being networked, wherein the environment information includes building information, road information, or weather information in some environments.

The simulated environment generating unit 322 is configured to generate the simulated environment based on the environment information. Upon acquiring the environment information, the simulated environment generating unit 322 simulates a virtual scenario based on the environment information. Specifically, an appropriate simulated environment may be selected according to the scope of the actual indoor site to create an environment approximate to a real world, so as to enable the user to have an immersive experience.

The simulated environment projecting unit 323 is configured to project the simulated environment. The simulated environment projecting unit 323 projects the simulated environment on a wall or other places, and displays the simulated scenario for the user in combination with AR glasses or similar device worn by the user, such that the user can see a relatively real simulated environment through the AR glasses or the like device.

The image generating module 33 is configured to generate a simulated image and apply the simulated image to the simulated environment. The user may set personal information by himself or herself, and the device generates the simulated image of the user based on the set personal information and applies the simulated image to the simulated scenario to simulate a nearly real experience scenario for the user. The simulated image may be the simulated image with the user as a subject, or may be an image of a virtual character set by the user. For example, in the case that the user wants to experience the feeling of exploring a primeval forest with his or her idol, he or she may set a virtual character of his or her idol and experience the item of exploring the primeval forest with the idol.

Optionally, the image generating module 33 further includes a personal information setting unit 331, a simulated image generating unit 332, and a simulated image applying unit 333.

The user sets the personal information by the input device. In the case that the personal information setting unit 331 receives a personal information set instruction, the simulated image generating unit 332 generates the simulated image according to the personal information input by the user, wherein the simulated image includes the image with the user as the subject and the simulated image set by the user, and the simulated image applying unit 333 applies the simulated image to the simulated environment, and determines a starting position during an experience course of the user and a virtual teammate.

The interaction responding module 34 is configured to receive an interaction action from a user and respond to the interaction action. The interaction responding module 34 may capture the action of the user in real time through an action capture device, a camera, or the like device, and change the simulated environment according to the action of the user, so as to achieve fusion of simulated information and real information. In the case that the user sets a virtual character image to accompany him to experience, the experience course of the virtual character is randomly selected and simulated. In addition, a voice instruction of the user is received and responded, the user speaking with the virtual character is supported and the virtual character is controlled to randomly react to the language of the user.

Referring to FIG. 6, FIG. 6 is a structural block diagram of an electronic device 400 according to some embodiments of the present disclosure. The electronic device 400 includes at least one processor 41, and a memory 42 communicably connected to the at least one processor 41. FIG. 6 uses one predecessor 41 as an example.

The memory 42 stores one or more instructions executable by the at least one processor 41, wherein at least one processor 41, when executing the one or more instructions, is caused to perform the method as described above.

The processor 41 and the memory 42 may be connected via a bus or in another manner, and FIG. 6 uses the bus as an example. The memory 42, as a non-volatile computer readable storage medium, may be configured to store non-volatile software programs, non-volatile computer executable programs and modules, for example, the program instructions/modules (for example, modules and units in FIG. 5) corresponding to the environment experiencing apparatus 300 in augmented reality according to the embodiments of the present disclosure. The non-volatile software programs, instructions and modules stored in the memory 42, when executed, cause the processor 41 to perform various function applications and data processing of a server, that is, performing the environment experiencing method in augmented reality according to the above method embodiments.

The memory 42 may include a program memory area and a data memory area, wherein the program memory area may store operating systems and application programs desired by at least one function; and the data memory area may store data created according to the use of the environment experiencing apparatus 300 based on augmented reality. In addition, the memory 42 may include a high-speed random-access memory, or include a non-volatile memory, for example, at least one disk storage device, a flash memory device, or another non-volatile solid storage device. In some embodiments, the memory 42 optionally includes memories 42 remotely configured relative to the processor 41. These memories may be connected to the electronic device 400 over a network. Examples of the above network include, but not limited to, the Internet, Intranet, local area network, mobile communication network and a combination thereof.

One or a plurality of modules are stored in the memory 42, and when executed by the at least one processor 41, perform the environment experiencing method in augmented reality according to any of the above embodiments, for example, performing steps in the method as illustrated in FIG. 1, FIG. 2, and FIG. 3.

The product may perform the method according to the embodiments of the present disclosure, has corresponding function modules for performing the environment experiencing method in augmented reality. For technical details that are not illustrated in detail in this embodiment, reference may be made to the description of the environment experiencing method in augmented reality according to the embodiments of the present disclosure.

The electronic device according to the embodiment of the present disclosure is practiced in various forms, including, but not limited to:
(1) a mobile communication device: which has the mobile communication function and is intended to provide mainly voice and data communications; such terminals include: a smart phone (for example, an iPhone), a multimedia mobile phone, a functional mobile phone, a low-end mobile phone and the like;
(2) a mobile personal computer device: which pertains to the category of personal computers and has the computing and processing functions, and additionally has the mobile Internet access feature; such terminals include: a PDA, a MID, a UMPC device and the like, for example, an iPad;
(3) a portable entertainment device: which di splays and plays multimedia content; such devices include: an audio or video player (for example, an iPod), a palm game machine, an electronic book, and a smart toy, and a portable vehicle-mounted navigation device;
(4) a server: which provides services for computers, and includes a processor, a hard disk, a memory, a system bus and the like; the server is similar to the general computer in terms of architecture; however, since more reliable services need to be provided, higher requirements are imposed on the processing capability, stability, reliability, security, extensibility, manageability and the like of the device; and
(5) another electronic device having the data interaction function.

An embodiment of the present disclosure further provides a non-volatile computer-readable storage medium, wherein the computer-readable storage medium stores computer-executable instructions, which, when executed by the at least one processor, for example, the processor 41 as illustrated in FIG. 6, cause the at least one processor to perform the environment experiencing method in augmented reality in any of the above method embodiments, for example, performing step S11 to step S14 in the method as illustrated in FIG. 1, step S121 to step S123 in the method as illustrated in FIG. 2, step S131 to step S133 in the method as illustrated in FIG. 3, and step S21 to step S26 in the method as illustrated in FIG. 4; and implementing the functions of module 31 to module 34, unit 321 to unit 323, and unit 331 to unit 333 as illustrated in FIG. 5.

An embodiment of the present disclosure further provides a computer program product. The computer program product includes a computer program stored in a non-volatile computer-readable storage medium. The computer program includes one or more program instructions, wherein the one or more program instructions, when executed by an electronic device, cause the electronic device to perform the environment experiencing method in augmented reality in any of the above method embodiments, for example, performing step S11 to step S14 in the method as illustrated in FIG. 1, step S121 to step S123 in the method as illustrated in FIG. 2, step S131 to step S133 in the method as illustrated in FIG. 3, and step S21 to step S26 in the method as illustrated in FIG. 4; and implementing the functions of module 31 to module 34, unit 321 to unit 323, and unit 331 to unit 333 as illustrated in FIG. 5.

The non-volatile computer-readable storage medium can include, but is not limited to, magnetic, optical, and/or semiconductor storages. Examples of such storage include magnetic disks, optical discs based on CD, DVD, or Blu-ray technologies, as well as persistent solid-state memory such as flash, solid-state drives, and the like.

The above described apparatus embodiments are merely for illustration purpose only. The units which are described as separate components may be physically separated or may be not physically separated, and the components which are illustrated as units may be or may not be physical units, that is, the components may be located in the same position or may be distributed into a plurality of network units. Part or all of the modules may be selected according to the actual needs to achieve the objects of the technical solutions of the embodiments.

According to the above embodiments of the present disclosure, a person skilled in the art may clearly understand that the embodiments of the present disclosure may be implemented by means of hardware or by means of software plus a necessary general hardware platform. Persons of ordinary skill in the art may understand that all or part of the steps of the methods in the embodiments may be implemented by a program instructing relevant hardware. The program may be stored in a computer-readable storage medium. When the program runs, the steps of the methods in the embodiments are performed. The storage medium may be any medium capable of storing program codes, such as a magnetic disk, a compact disc read-only memory (CD-ROM), a read-only memory (ROM), a random-access memory (RAM), or the like.

Finally, it should be noted that the above embodiments are merely used to illustrate the technical solutions of the present disclosure rather than limiting the technical solutions of the present disclosure. Under the concept of the present disclosure, the technical features of the above embodiments or other different embodiments may be combined, the steps therein may be performed in any sequence, and various variations may be derived in different aspects of the present disclosure, which are not detailed herein for brevity of description. Although the present disclosure is described in detail with reference to the above embodiments, persons of ordinary skill in the art should understand that they may still make modifications to the technical solutions described in the above embodiments, or make equivalent replacements to some of the technical features; however, such modifications or replacements do not cause the essence of the corresponding technical solutions to depart from the spirit and scope of the technical solutions of the embodiments of the present disclosure.

What is claimed is:

1. An environment experiencing method in augmented reality, the method applicable to an electronic device, the method comprising:
receiving an item select instruction;
generating a simulated environment of a specified item based on the item select instruction;
generating a simulated image and applying the simulated image to the simulated environment; and
receiving an interaction action from a user and responding to the interaction action.

2. The environment experiencing method in augmented reality according to claim 1, wherein generating the simulated environment of the specified item based on the item select instruction comprises:
acquiring environment information of the specified item;
generating the simulated environment based on the environment information; and
projecting the simulated environment.

3. The environment experiencing method in augmented reality according to claim 2, wherein generating the simulated environment based on the environment information comprises:
simulating a virtual scenario based on the environment information; and
creating the simulated environment approximate to a real world.

4. The environment experiencing method in augmented reality according to claim 1, wherein generating the simulated image and applying the simulated image to the simulated environment comprises:
receiving a personal information set instruction;
generating the simulated image based on the personal information set instruction; and
applying the simulated image to the simulated environment.

5. The environment experiencing method in augmented reality according to claim 1, further comprising: receiving an experience time set instruction from the user, and planning an experience process of the specified item based on the experience time set instruction.

6. The environment experiencing method in augmented reality according to claim 1, further comprising: recording and storing an experience course of the user; wherein the experience course comprises image information and sound information.

7. The environment experiencing method in augmented reality according to claim 1, further comprising:
receiving a correct instruction from the user and responding to the correct instruction in real time.

8. An electronic device, comprising:
at least one processor; and
a memory communicably connected with the at least one processor and for storing instructions executable by the at least one processor,
wherein execution of the instructions by the at least one processor causes the at least one processor to execute the environment experiencing method in augmented reality;
wherein the environment experiencing method in augmented reality comprises:
receiving an item select instruction;
generating a simulated environment of a specified item based on the item select instruction;
generating a simulated image and applying the simulated image to the simulated environment; and
receiving an interaction action from a user and responding to the interaction action.

9. The electronic device according to claim 8, wherein generating the simulated environment of the specified item based on the item select instruction comprises:
acquiring environment information of the specified item;
generating the simulated environment based on the environment information; and
projecting the simulated environment.

10. The electronic device according to claim 9, wherein generating the simulated environment based on the environment information comprises:
simulating a virtual scenario based on the environment information; and
creating the simulated environment approximate to a real world.

11. The electronic device according to claim 8, wherein generating the simulated image and applying the simulated image to the simulated environment comprises:
receiving a personal information set instruction;
generating the simulated image based on the personal information set instruction; and
applying the simulated image to the simulated environment.

12. The electronic device according to claim 8, wherein the environment experiencing method further comprising: receiving an experience time set instruction from the user, and planning an experience process of the specified item based on the experience time set instruction.

13. The electronic device according to claim 8, wherein the environment experiencing method further comprising: recording and storing an experience course of the user; wherein the experience course comprises image information and sound information.

14. The electronic device according to claim 8, wherein the environment experiencing method further comprising:
receiving a correct instruction from the user and responding to the correct instruction in real time.

15. A non-volatile computer-readable storage medium storing one or more computer-executable instructions; wherein the one or more computer-executable instructions, when executed by an electronic device, cause the electronic device to execute the environment experiencing method in augmented reality;
wherein the environment experiencing method in augmented reality comprises:
receiving an item select instruction;
generating a simulated environment of a specified item based on the item select instruction;
generating a simulated image and applying the simulated image to the simulated environment; and
receiving an interaction action from a user and responding to the interaction action.

16. The non-volatile computer-readable storage medium according to claim 15, wherein generating the simulated environment of the specified item based on the item select instruction comprises:
acquiring environment information of the specified item;
generating the simulated environment based on the environment information; and
projecting the simulated environment.

17. The non-volatile computer-readable storage medium according to claim 16, wherein generating the simulated environment based on the environment information comprises:
simulating a virtual scenario based on the environment information; and
creating the simulated environment approximate to a real world.

18. The non-volatile computer-readable storage medium according to claim 15, wherein generating the simulated image and applying the simulated image to the simulated environment comprises:
receiving a personal information set instruction;
generating the simulated image based on the personal information set instruction; and
applying the simulated image to the simulated environment.

19. The non-volatile computer-readable storage medium according to claim 15, wherein the environment experiencing method further comprising: receiving an experience time set instruction from the user, and planning an experience process of the specified item based on the experience time set instruction.

20. The non-volatile computer-readable storage medium according to claim 15, wherein the environment experiencing method further comprising: recording and storing an experience course of the user; wherein the experience course comprises image information and sound information.
